(19) United States
(12) Patent Application Publication
(10) Pub. No.: US 2004/0248609 A1
(43) Pub. Date: Dec. 9, 2004

(54) Power control method and power control circuit

(76) Inventor: Koichi Tamura, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/852,226

(22) Filed: May 25, 2004

(30) Foreign Application Priority Data
Jun. 3, 2003 (JP) 2003-158173

(51) Int. Cl. H04B 1/707

(52) U.S. Cl. 455/522

(57) ABSTRACT

The present invention is a power control method of sending an order concerning signal transmission power to a transmission side apparatus which transmits the signal from a reception side apparatus which receives a signal transmitted by taking a code block unit, the method comprises the steps of: obtaining a difference between an average error rate of block error rates concerning a plurality of code blocks received from the transmission side apparatus and a preset target error rate by the reception side apparatus, and sending an order concerning the transmission power to the transmission side apparatus on the basis of history of the difference obtained every predetermined interval.

### BACKGROUND OF THE INVENTION

The present invention relates to a power control method suitable for controlling transmission power in radio communication conducted in a communication environment susceptible to a change, such as mobile communication, and a power control circuit for executing the method.

As a conventional method for maintaining a proper communication quality in a mobile communication system, outer loop power control, which increases and decreases a power level of a transmission signal, is known. As a technique of this kind, for example, there is a technique described in Japanese Patent Publication No. 2003-32184 A (page 3, FIG. 1). According to this technique, in outer loop power control at the CDMA (Code Division Multiple Access) communication system, a power level of a signal is controlled by correcting a target value of an SIR (Signal to Interference Ratio) on the basis of a bit error rate (BER) of a received signal.

In the conventional outer loop control, however, determination of the power level is conducted on the basis of a single error rate. For example, when the error rate has abruptly increased because of a change in the communication environment, therefore, the power is increased in response to the increase even if the increase in error rate is temporary. As a result, the possibility that another signal will be subject to interference increases because of an influence of the signal transmitted with the high power. On the contrary, if the transmission power is decreased in response to a temporary decrease in error rate, there is a fear that the transmission quality will be degraded. In this way, the conventional technique has a problem that drawbacks described above are caused by immediately coping with a change in communication environment.

### SUMMARY OF THE INVENTION

The present invention has been achieved in order to solve the above-described problems. An object of the present invention is to provide a power control method, and power control circuit, that conducts proper outer loop power control with due regard to a change in communication quality.

A power control method according to the present invention is a power control method of sending an order concerning signal transmission power to a transmission side apparatus which transmits the signal from a reception side apparatus which receives a signal transmitted by taking a code block as unit, the method comprises the steps of: obtaining a difference between an average error rate of block error rates concerning a plurality of code blocks received from the transmission side apparatus and a preset target error rate by the reception side apparatus, and sending an order concerning the transmission power to the transmission side apparatus on the basis of history of the difference obtained every predetermined interval.

A first aspect of a power control circuit for implementing a power control method according to the present invention includes an error rate measurement section for measuring a block error rate of a signal transmitted by taking a code block as the unit, and obtaining an average error rate of block error rates concerning a plurality of code blocks, an error rate comparison section for obtaining a difference between the average error rate and a preset target error rate, a quality judgment section for judging a communication quality on the basis of history for a predetermined interval, of the difference obtained by the error rate comparison section, and a power control determination section for determining control contents of transmission power of a signal on the basis of a result of judgment conducted by the quality judgment section.

A second aspect of a power control circuit according to the present invention includes an error rate measurement section for measuring a block error rate of a code block, and obtaining an average error rate of block error rates concerning a plurality of code blocks, an error rate comparison section for obtaining a difference between the average error rate and a preset target error rate, and an average processing control section for judging a communication quality on the basis of history for a predetermined interval, of the difference obtained by the error rate comparison section, and ordering the error rate measurement section to increase or decrease an interval concerning the average error rate to the error rate measurement section.

### BRIEF DESCRIPTION OF THE DRAWINGS

FIG. 1 is a block diagram showing a configuration of a first embodiment of a power control circuit according to the present invention;

FIG. 2 is a flow chart showing an operation of a power control circuit of a first embodiment according to the present invention;

FIG. 3 is a first diagram showing history of a BLER in a first embodiment according to the present invention;

FIG. 4 is a second diagram showing history of a BLER in a first embodiment according to the present invention;

FIG. 5 is a third diagram showing history of a BLER in a first embodiment according to the present invention;

FIG. 6 is a fourth diagram showing history of a BLER in a first embodiment according to the present invention;

FIG. 7 is a block diagram showing a configuration of a second embodiment of a power control circuit according to the present invention;

FIG. 8 is a first diagram showing a block control example of a power control circuit in a second embodiment according to the present invention; and

FIG. 9 is a second diagram showing a block control example of a power control circuit in a second embodiment according to the present invention.

### DESCRIPTION OF THE PREFERRED EMBODIMENTS

Hereafter, embodiments of the present invention will be described in detail with reference to the drawings.

### First Embodiment

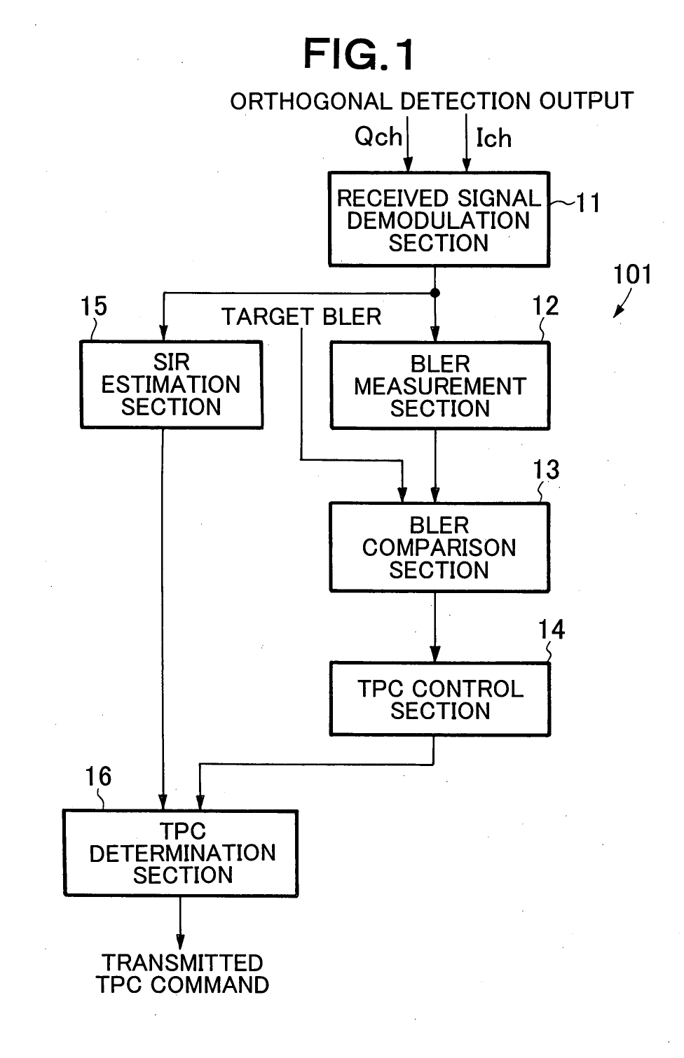

FIG. 1 is a block diagram showing a first embodiment of a power control circuit for executing a power control method according to the present invention. A power control circuit 101 in the first embodiment is provided in a reception side apparatus for receiving a signal transmitted in radio communication of the CDMA system. The power control circuit 101 exercises outer loop power control for giving an order concerning signal transmission power to a transmission side apparatus. A code block transmitted between the reception side apparatus and the transmission side apparatus indicates a unit that forms one error correction word.

As shown in FIG. 1, the power control circuit 101 includes a received signal demodulation section 11 for conducting typical demodulation processing such as despreading processing and error correction processing on an I component and a Q component obtained by conducting orthogonal detection on a received signal, a BLER measurement section 12 for making a decision on a CRC (Cyclic Redundancy Check) bit of each code block demodulated by the demodulation section 11, measuring a block error rate (hereafter abbreviated to BLER) of each block, and obtaining an average BLER from a predetermined number of successively measured BLERs, a BLER comparison section 13 for obtaining a difference between the average BLER and a preset target BLER, a TPC (Transmit Power Control) section 14 serving as a quality decision section for judging a communication quality of radio communication on the basis of history of the difference obtained by the BLER comparison section 13 over each predetermined interval, an SIR estimation section 15 for estimating an SIR on the basis of a signal output from the received signal demodulation section 11, and a TPC determining section 16 serving as a power control determining section for determining contents of a power control order to be supplied to the transmission side apparatus on the basis of a result of the quality judgment conducted by the TPC control section 14.

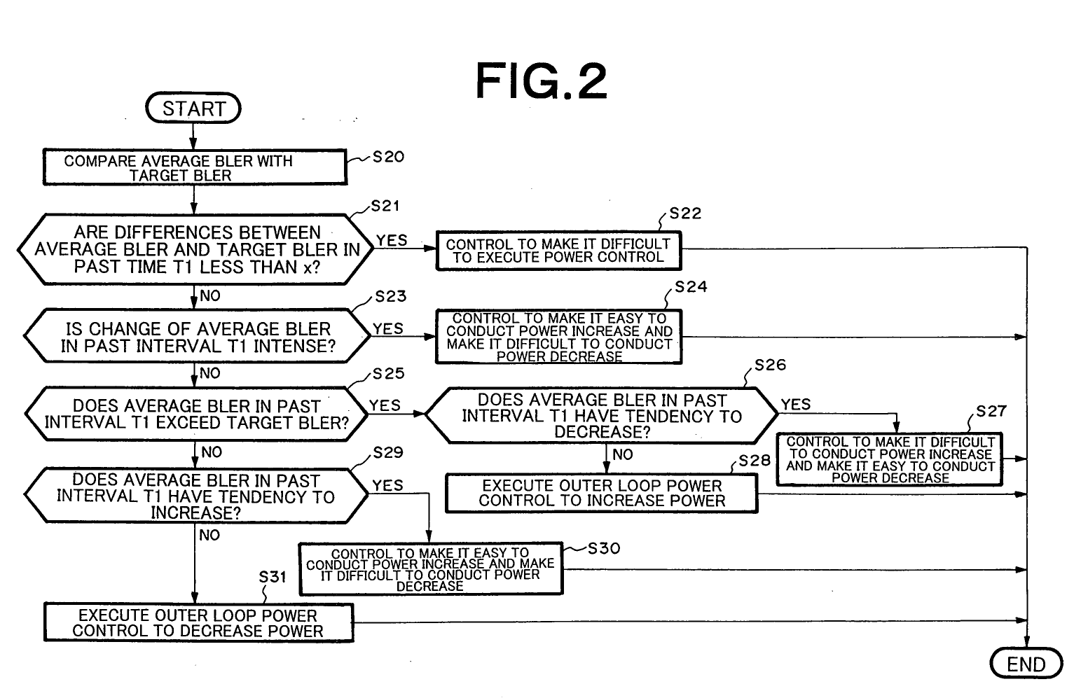

Operation of the power control circuit 101 will now be described with reference to a flow chart shown in FIG. 2. First, code blocks obtained by demodulation processing in the received signal demodulation section 11 are successively supplied to the BLER measurement section 12. The BLER measurement section 12 measures a BLER every block, and then obtains an average BLER concerning a plurality of code blocks. The BLER comparison section 13 compares the average BLER with the target BLER and obtains a difference between them (step S20).

The TPC control section 14 judges a communication quality every predetermined interval T1 on the basis of history of the difference obtained by the BLER comparison section 13 over each predetermined interval. A result of this decision is applied to power control described later until the interval T1 elapses. The predetermined interval T1 can be made, for example, equal to an interval over which a predetermined number of average BLERs are calculated. The TPC control section 14 refers to history of the difference, and judges the communication quality on the basis of whether a predetermined number of recorded differences is less than a preset allowable value x (step S21). When the predetermined number of differences is less than the allowable value x (YES at the step S21), the TPC control section 14 judges that the communication quality is proper and stable, and notifies the TPC determination section 16 to that effect.

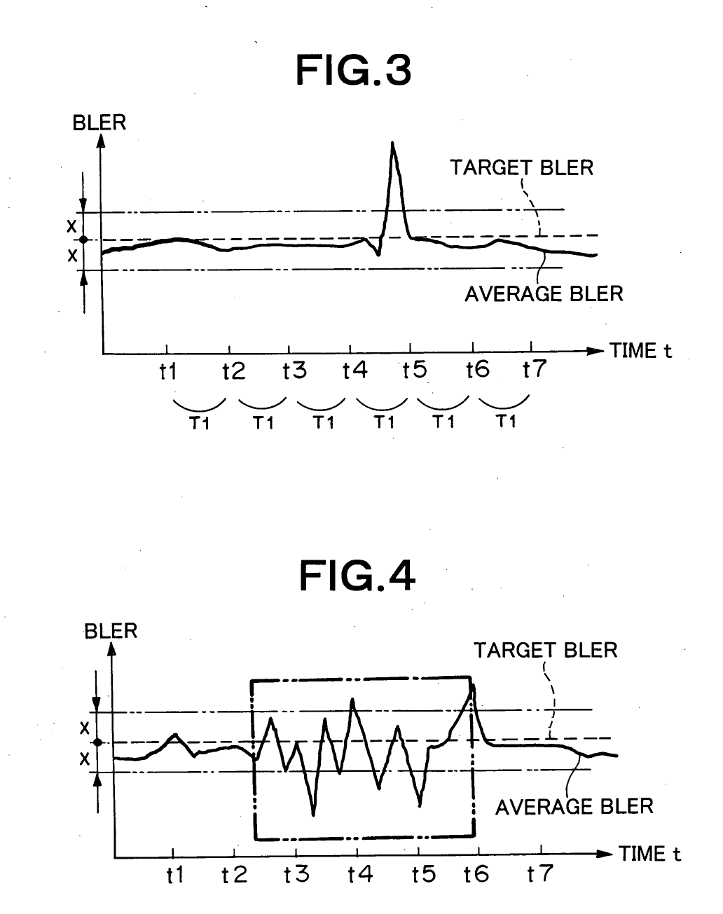

As an example of the judgment, it is supposed that differences at three past points in time are referred to, and history of the BLER as shown in FIG. 3 has been obtained. In the example shown in FIG. 3, the average BLER approximates to the target value between time t1 and t4 and between time t6 and t7. At time t5, however, the communication quality is temporarily degraded by a change or the like in communication environment, and the difference exceeds x. As the quality judgment at the point t5 in time, the TPC control section 14 judges the communication quality to be stable, because all differences at past points t2 to t4 in time are less than x although the difference at the point t5 in time exceeds the allowable value x.

Upon receiving the result of the judgment conducted by the TPC control section 14, the TPC determination section 16 orders the transmission side apparatus to suppress the increase or decrease in transmission power in order to maintain the transmission power in the present state (step S22). This order is given by using a TPC command. For example, a command for stopping the power increase or decrease or a command for causing the power increase and decrease at the same frequencies is transmitted. As a result, the power level in the present state is maintained, and in addition, it is possible to prevent unnecessary power increase caused in response to temporary quality degradation.

When a predetermined number of differences in the history are the allowable value x or more (NO at the step S21), the TPC control section 14 determines whether transition of the average BLER in the pertinent interval is intense (step S23). For example, paying attention to time t6 in history as shown in FIG. 4, it is judged that the change of the average BLER is intense between past points t3 and t5. As for a criterion for the judgment, for example, it is judged that the change is intense when three or more peaks exceeding the allowable value x have been ascertained in the transition of the average BLER. In this way, the judgment criterion can be set suitably. When the change of the average BLER is thus intense (YES at the step S23), it is judged that the communication quality is unstable and there is a possibility that fatal quality degradation will be caused. Upon receiving the judgment result, the TPC determination section 16 issues an order for suppressing the power decrease, i.e., an order for facilitating power increase and making power decrease difficult, in order to avoid fatal quality degradation (step S24).

Typically, which of the single TPC command and a plurality of TPC commands is to be used to control power increase and decrease is set between the reception side apparatus and the transmission side apparatus. “Exercising power control by using a single command” means that an order according to the command is executed each time the transmission side apparatus receives a command from the reception side apparatus. “Exercising power control by using a plurality of commands” means that, for example, when a command having the same order contents has been received a predetermined number of times the order is first executed, i.e., commands of the same kind are thinned.

It is now supposed that the reception side apparatus is to make it easy for the transmission side apparatus to conduct power increase or decrease in the embodiment of the present invention. For example, if the control using a plurality of TPC commands is set, then the reception side apparatus orders the transmission side apparatus to change it to the control using a single command and conduct power increase or decrease under this setting. If the control using a single command is already conducted, then the reception side apparatus orders the transmission side apparatus to increase the control width at the time of power increase or decrease as compared with that in the present state.

On the contrary, it is now supposed that the reception side apparatus is to make it difficult for the transmission side apparatus to conduct power increase or decrease. For example, if the control using a single TPC command is set, then the reception side apparatus orders the transmission side apparatus to change it to the control using a plurality of commands. If the control using a plurality of commands is already conducted, then the reception side apparatus orders the transmission side apparatus to decrease the control width at the time of power increase or decrease as compared with that in the present state. Or the reception side apparatus orders the transmission side apparatus to insert a command for ordering the increase and a command for ordering the decrease before and after a command to be suppressed in execution, at the same frequencies.

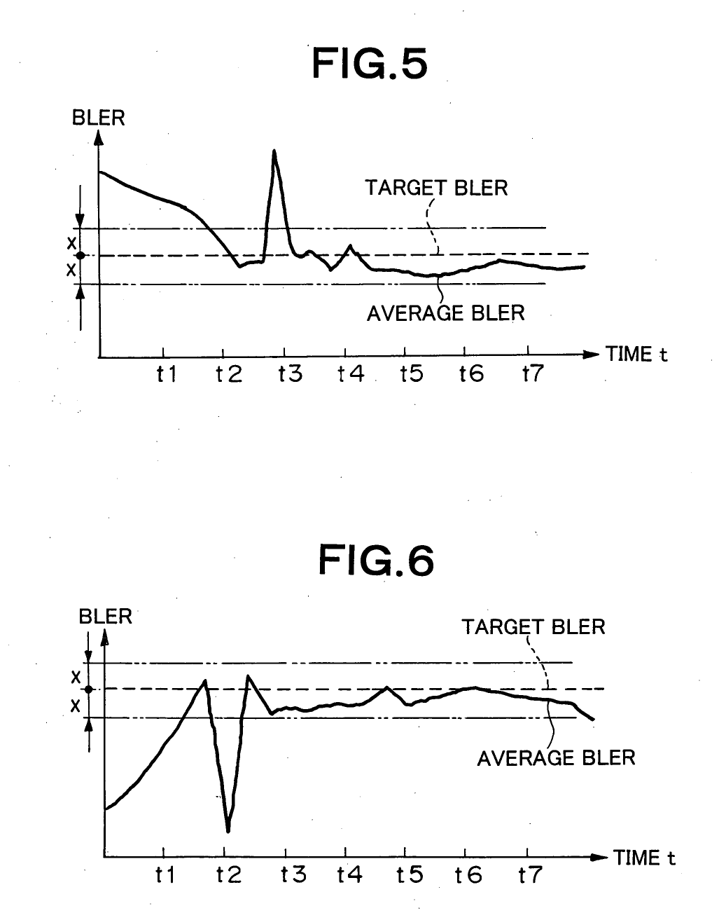

If the TPC control section 14 judges that the past average BLER is not intense in change (NO at the step S23) and the past average BLER exceeds the target BLER (YES at the step S25), then the TPC control section 14 determines whether the average BLER in the pertinent interval tends to decrease (step S26). For example, observing the transition of the average BLER between time t1 and time t4 in history shown in FIG. 5, the average BLER first exceeds the target value, but tends to fall toward time t4 (YES at the step S26). In such a case, the TPC control section 14 judges that the communication quality has a tendency to be improved at the time t4. Upon being notified to that effect, the TPC determination section 16 issues an order for suppressing the power increase, i.e., an order for making the power increase difficult and making the power decrease easy (step S27). Or the TPC determination section 16 may issue an order for suppressing the power increase and decrease in order to maintain the power level in the present state.

If the average BLER is not decreased even when the time t4 is arrived at and the communication quality is judged to have no tendency to be improved, then the TPC determination section 16 regards the degradation as fatal quality degradation, and issues an order similar to a power increase order using the conventional outer loop power control. In other words, the TPC determination section 16 orders the transmission side apparatus to conduct the power increase and not to conduct the power decrease (step S28).

If the past average BLER is gentle in change and it does not exceed the target value (NO at the step S25), but the average BLER has a tendency to increase in the pertinent interval (YES at step S29), then the TPC determination section 16 judges that there is a possibility that the communication quality will be brought to fatal degradation. For example, in history shown in FIG. 6, the increase tendency of the average BLER is seen between time t2 and t4. In order to prevent fatal degradation of the communication quality, therefore, the TPC determination section 16 orders the transmission side apparatus to make it easy to increase power and make it difficult to decrease power (step S30). Or the TPC determination section 16 may issue an order for suppressing the power increase and decrease in order to maintain the power level in the present state.

If the past average BLER is judged to have no tendency to increase (NO at the step S29), then the TPC determination section 16 judges that the communication environment is extremely good and the transmission power at a level in the present state is excessive in the environment, and issues an order similar to a power decrease order using the conventional outer loop power control not to conduct the power increase and to conduct the power decrease (step S31).

When determining contents of the order issued to the transmission side apparatus, the TPC determining section 16 refers to the SIR estimated by the SIR estimation section 15, and recognizes the transmission power level in the present state. As a result, the TPC determining section 16 is prevented from ordering the transmission side apparatus to increase or decrease power in excess of a predetermined upper limit value or lower limit value concerning the transmission power.

According to the power control circuit 101 of the first embodiment, power control is exercised according to the communication quality judged on the basis of the history concerning the average BLER. Therefore, it is possible to conduct proper outer loop power control with due regard to history of the change in the communication environment without being affected by a temporary change of the average BLER.

### Second Embodiment

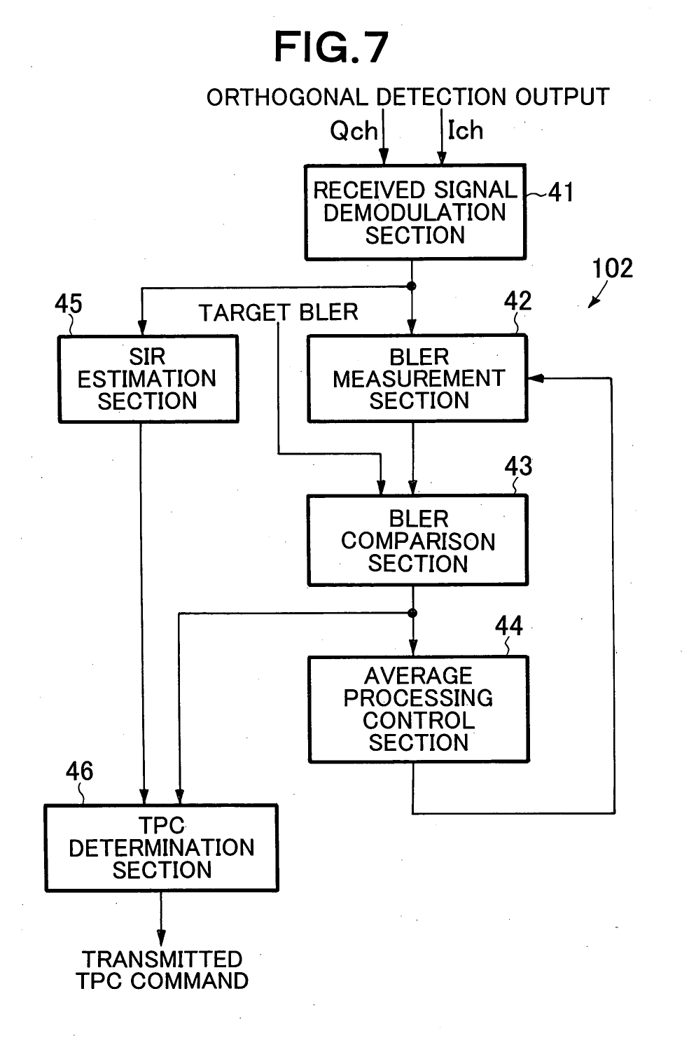

FIG. 7 is a block diagram showing a second embodiment of a power control circuit for executing a power control method according to the present invention. As shown in FIG. 7, a power control circuit 102 of the second embodiment includes a received signal demodulation section 41, a BLER measurement section 42, a BLER comparison section 43 and an SIR estimation section 45, which perform functions respectively similar to those of the received signal demodulation section 11, the BLER measurement section 12, the BLER comparison section 13 and the SIR estimation section 15 included in the power control circuit 101 of the first embodiment. The power control circuit 102 includes an average processing control section 44 for exercising control concerning the average BLER described later to the BLER measurement section 42.

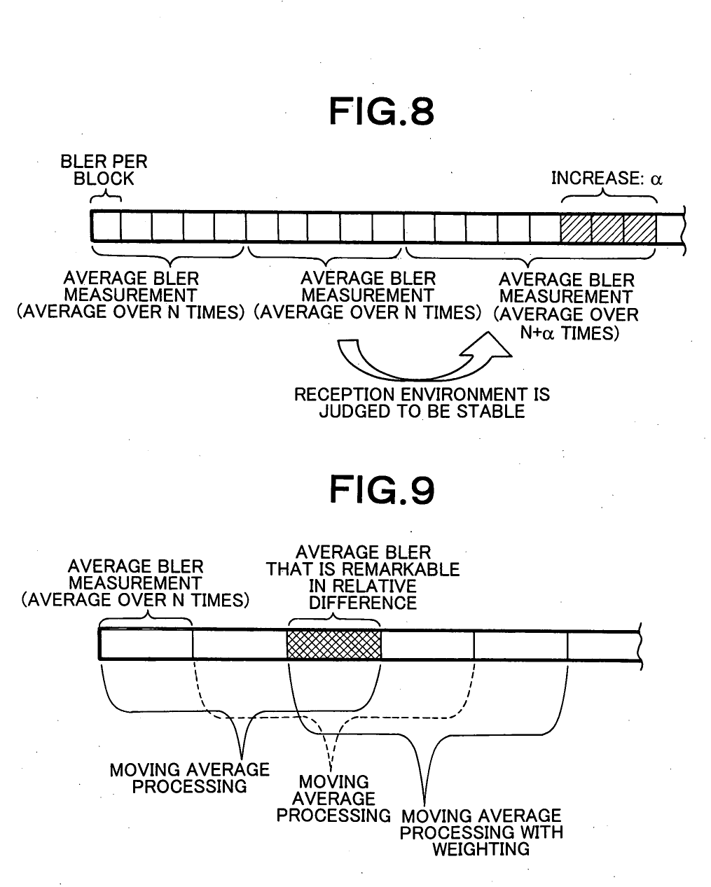

The average processing control section 44 judges the communication quality on the basis of history concerning the average BLER along a procedure similar to the procedure of the TPC control section 14 of the first embodiment. When the average processing control section 44 has judged the communication quality, the average processing control section 44 issues an order for increasing or decreasing an interval concerning the average BLER, i.e., the quantity of code blocks concerning the calculation of one average BLER to the BLER measurement section 42 on the basis of a result of the judgment. For example, it is now supposed that the average processing control section 44 has judged that the communication quality is good when calculating the average BLER from N blocks, as shown in FIG. 8. At the time of calculation of the next average BLER, the average processing control section 44 orders the BLER measurement section 42 to increase the number of blocks by α and calculate the average BLER by using (N+α) blocks. In this way, the quantity of blocks is increased when the communication quality is good. Even if a high level BLER temporarily occurs, therefore, the influence of the high level BLER exerted on the result of the average BLER can be mitigated. As a result, power control with due regard to a temporary change of the communication quality can be exercised. If the average processing control section 44 judged the communication quality to be degraded, then the average processing control section 44 orders the BLER measurement section 42 to decrease the number of code blocks as compared with the number in the present state. By decreasing the number of blocks, the judgment subject of the communication quality can be sampled densely as compared with the present state. As a result, the monitoring of the communication quality is strengthened and further degradation of the quality can be prevented.

In the power control circuit 102, a difference between the target BLER and the average BLER obtained under the control of the average processing control section 44 is supplied from the BLER comparison section 43 to the TPC determination section 46. On the basis of the supplied difference, the TPC determination section 46 issues a power increase or decrease order to the transmission side apparatus. For example, if the average BLER is greater than the target BLER, then the TPC determination section 46 issues a power increase order in order to improve the degradation of the communication quality. If the average BLER is less than the target BLER, then the communication environment is good, and consequently the TPC determination section 46 issues a power decrease order in order to save the power.

As another control method concerning the average processing executed by the average processing control section 44, a procedure described hereafter can be adopted. This procedure is premised on that the BLER measurement section 42 calculates a moving average BLER from average BLERs obtained successively every predetermined number of code blocks, by using moving average processing and the BLER comparison section 43 obtains a difference between the moving average BLER and the target BLER. In this case, as shown in FIG. 9, the average processing control section 44 detects an average BLER that becomes remarkable in difference from its preceding or subsequent average BLER because of a temporary change or the like of the communication environment. And the average processing control section 44 orders the BLER measurement section 42 to provide the average BLER with a weight so as to reduce the difference from the its preceding or subsequent average BLER when conducting the moving average processing containing the detected average BLER. For example, if the detected average BLER has a value that is extremely higher than its preceding or subsequent value, the detected average BLER is provided with a weight for decreasing it as compared with its actual value. If the detected average BLER has a value that is extremely lower than its preceding or subsequent value, the detected average BLER is provided with a weight for increasing it as compared with its actual value. As a result, influence of an average BLER that is remarkable in difference from its preceding or subsequent value is mitigated at the time of the moving average processing. Power control with due regard to a temporary change of the communication quality can thus be conducted.

According to the power control method of the present invention, the reception side apparatus conducts power control on the basis of history concerning the code block error rate. Therefore, it is possible to conduct proper outer loop power control with due regard to the change of the communication environment, without conducting improper power control in response to a temporary change of the error rate.

According to the first configuration of a power control circuit of the present invention, the power control determination section determines contents of control exercised on the transmission side apparatus on the basis of a result of judgment conducted by the quality control section, which judges the communication quality on the basis of history concerning the code block error rate. Therefore, it is possible to prevent improper power increase or decrease responsive to a temporary change of the error rate.

According to the second configuration of a power control circuit of the present invention, the average processing control section increases or decreases the interval concerning average processing according to a communication quality judged on the basis of the history concerning the error rate. Therefore, it is possible to mitigate the influence of a temporary quality change in judgment of the communication quality. As a result, effects similar to those of the first configuration can be brought about.

What is claimed is:

1. A power control method of sending an order concerning signal transmission power to a transmission side apparatus which transmits the signal from a reception side apparatus which receives a signal transmitted by taking a code block unit, the method comprises the steps of:
obtaining a difference between an average error rate of block error rates concerning a plurality of code blocks received from the transmission side apparatus and a preset target error rate by the reception side apparatus, and
sending an order concerning the transmission power to the transmission side apparatus on the basis of history of the difference obtained every predetermined interval.

2. The power control method according to claim 1, wherein
contents of the order is determined on the basis of a result of comparison between a predetermined number of differences in the history and an allowable value preset for differences.

3. The power control method according to claim 2, wherein
when the predetermined number of differences are less than the allowable value, the reception side apparatus orders the transmission side apparatus to suppress the increase and decrease of transmission power.

4. The power control method according to claim 2, wherein
when the predetermined number of differences are greater than or equal to the allowable value and a change of the history satisfies a predetermined condition prescribing an unstable communication quality, the reception side apparatus orders the transmission side apparatus to make it easy to increase transmission power and make it difficult to decrease the transmission power.

5. The power control method according to claim 2, wherein
the reception side apparatus orders the transmission side apparatus to make it difficult to increase transmission power and make it easy to decrease the transmission power, when the predetermined number of differences are greater than or equal to the allowable value, a change of the history does not satisfy a predetermined condition prescribing an unstable communication quality, an average error rate corresponding to the predetermined number of differences is higher than the target error rate, and a change of the average error rate has a tendency to decrease.

6. The power control method according to claim 2, wherein
the reception side apparatus orders the transmission side apparatus to suppress increase and decrease of transmission power, when the predetermined number of differences are greater than or equal to the allowable value, a change of the history does not satisfy a predetermined condition prescribing an unstable communication quality, an average error rate corresponding to the predetermined number of differences is higher than the target error rate, and a change of the average error rate has a tendency to decrease.

7. The power control method according to claim 2, wherein
the reception side apparatus orders the transmission side apparatus to make it easy to increase transmission power and make it difficult to decrease the transmission power, when the predetermined number of differences are greater than or equal to the allowable value, a change of the history does not satisfy a predetermined condition prescribing an unstable communication quality, an average error rate corresponding to the predetermined number of differences is lower than the target error rate, and a change of the average error rate has a tendency to increase.

8. The power control method according to claim 2, wherein
the reception side apparatus orders the transmission side apparatus to suppress increase and decrease of transmission power, when the predetermined number of differences are greater than or equal to the allowable value, a change of the history does not satisfy a predetermined condition prescribing an unstable communication quality, an average error rate corresponding to the predetermined number of differences is lower than the target error rate, and a change of the average error rate has a tendency to increase.

9. The power control method according to claim 1, wherein
a communication quality between the reception side apparatus and the transmission side apparatus is judged on the basis of the history, and
an interval concerning the average error rate is increased or decreased on the basis of a result of the judgment.

10. The power control method according to claim 1, wherein
the average error rate is a value obtained by conducting a moving average processing on each of error rate average values concerning a plurality of code blocks, and
an average value that has a remarkable relative difference and that is included in the average values to be subject to the moving average processing is provided with a predetermined weight for decreasing the difference, followed by subjecting to the moving average processing.

11. A power control circuit comprising:
an error rate measurement section for measuring a block error rate of a signal transmitted by taking a code block unit, and obtaining an average error rate of block error rates concerning a plurality of code blocks;
an error rate comparison section for obtaining a difference between the average error rate and a preset target error rate;
a quality judgment section for judging a communication quality on the basis of history for a predetermined interval, of the difference obtained by the error rate comparison section; and
a power control determination section for determining control contents of transmission power of a signal on the basis of a result of judgment conducted by the quality judgment section.

12. The power control circuit according to claim 11, wherein
the quality judgment section judges the communication quality on the basis of a result of comparison between a predetermined number of differences in the history and an allowable value preset for differences, and notifies the power control determination section of a result of the judgment.

13. The power control circuit according to claim 12, wherein
when the predetermined number of differences are less than the allowable value, the quality judgment section notifies the power control determination section of a judgment result for exercising control in order to suppress the increase and decrease of transmission power.

14. The power control circuit according to claim 12, wherein
when the predetermined number of differences are greater than or equal to the allowable value and a change of the history satisfies a predetermined condition prescribing an unstable communication quality, the quality judgment section notifies the power control determination section of a judgment result for exercising control in order to make it easy to increase transmission power and make it difficult to decrease the transmission power.

15. The power control circuit according to claim 12, wherein
the quality judgment section notifies the power control determination section of a judgment result for exercising control in order to make it difficult to increase transmission power and make it easy to decrease the transmission power, when the predetermined number of differences are greater than or equal to the allowable value, a change of the history does not satisfy a predetermined condition prescribing an unstable communication quality, an average error rate corresponding to the predetermined number of differences is higher than the target error rate, and a change of the average error rate has a tendency to decrease.

16. The power control circuit according to claim 12, wherein
the quality judgment section notifies the power control determination section of a judgment result for exercising control in order to suppress the increase and decrease of transmission power, when the predetermined number of differences are greater than or equal to the allowable value, a change of the history does not satisfy a predetermined condition prescribing an unstable communication quality, an average error rate corresponding to the predetermined number of differences is higher than the target error rate, and a change of the average error rate has a tendency to decrease.

17. The power control circuit according to claim 12, wherein
the quality judgment section notifies the power control determination section of a judgment result for exercising control in order to make it easy to increase transmission power and make it difficult to decrease the transmission power, when the predetermined number of differences are greater than or equal to the allowable value, a change of the history does not satisfy a predetermined condition prescribing an unstable communication quality, an average error rate corresponding to the predetermined number of differences is lower than the target error rate, and a change of the average error rate has a tendency to increase.

18. The power control circuit according to claim 12, wherein
the quality judgment section notifies the power control determination section of a judgment result for exercising control in order to suppress increase and decrease of transmission power, when the predetermined number of differences are greater than or equal to the allowable value, a change of the history does not satisfy a predetermined condition prescribing an unstable communication quality, an average error rate corresponding to the predetermined number of differences is lower than the target error rate, and a change of the average error rate has a tendency to increase.

19. A power control circuit comprising:
an error rate measurement section for measuring a block error rate of a code block, and obtaining an average error rate of block error rates concerning a plurality of code blocks;
an error rate comparison section for obtaining a difference between the average error rate and a preset target error rate; and
an average processing control section for judging a communication quality on the basis of history for a predetermined interval, of the difference obtained by the error rate comparison section, and ordering the error rate measurement section to increase or decrease an interval concerning the average error rate.

20. The power control circuit according to claim 19, wherein
the error rate measurement section obtains the average error rate by conducting a moving average processing on each of error rate average values concerning a plurality of code blocks, and
the average processing control section includes means for detecting an average value that has a remarkable relative difference and that is included in the average values to be subject to moving average processing, and the average processing control section orders the error rate measurement section to provide the detected average value with a predetermined weight for decreasing the difference, followed by subjecting to the moving average processing.
